(19) United States
(12) Patent Application Publication
(10) Pub. No.: US 2006/0095340 A1
(43) Pub. Date: May 4, 2006

(54) Personalized event multimedia capture system

(75) Inventors: Marc Iadanza, Sherman Oaks, CA (US); Umesh Pathak, Los Angeles, CA (US); Abram Lietz, San Marcos, CA (US); Chris Gunnarson, Truckee, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: PIO, LLC.

(21) Appl. No.: 11/236,409

(22) Filed: Sep. 26, 2005

Related U.S. Application Data
(60) Provisional application No. 60/612,840, filed on Sep. 24, 2004.

(51) Int. Cl. G06Q 30/00

(52) U.S. Cl. 705/26

(57) ABSTRACT

A method including the steps of receiving payment from a user, assigning an user identification to the user, detecting a user identification, and capturing multimedia information related to the user identification. Then, the multimedia information is transferred to a remote location; a reduced version (thumbnail) of the multimedia information is displayed; and, the multimedia information is produced onto a removable storage media. A system and apparatus is also disclosed for performing the described method.

### CLAIM OF PRIORITY UNDER 35 U.S.C. §119

The present Application for patent claims priority to Provisional Application No. 60/612,840 entitled “PERSONALIZED EVENT MULTIMEDIA CAPTURE SYSTEM” filed Sep. 24, 2004, and assigned to the assignee hereof and hereby expressly incorporated by reference herein.

### FIELD OF THE INVENTION

The present invention relates generally to capturing and distributing multimedia for an event, and more particularly, to a personalized event multimedia capture system.

### BACKGROUND OF THE INVENTION

In the current competitive economic environment where most resort operators are avoiding capital investments and service development expenses, provision of managed service has emerged as the single most viable option for resorts to grow revenue. For a resort operator the key barrier to outsourcing any service, especially capital intensive offerings, is being assured of the capabilities of the provider and the relevancy of the service. Thus, resort operators, who are marginally competitive in these areas, welcome innovative service offerings designed to delight their customers while limiting product development costs.

The market for personalized and content rich media represents a logical evolution toward harnessing network (e.g., wireless) and media storage (e.g., DVD) technology with sporting activities. With the proliferation of global access to wireless services, a greater emphasis on leisure and sport will only increase the consumer's appetite for personalized content.

For example, one popular type of resort activity is snow sports (e.g., skiing, snowboarding, sledding, etc.). Some statistics compiled in the early 2000's gauge the number of annual U.S. visitors to snow parks in excess of $54 MM. Japanese, Canadian and select European destinations also represent large markets. As winter sports becomes more mainstream over the next few years and an increasingly active population begins to participate in them, the leading service delivery firms will continue to create markets and dominate them on a value creation basis. Similarly, golf and other resort activities have been popular and the markets for these are increasing in size.

Visitors to these venues would often like to have personalized media content of the activities they participate in. However, it is difficult for visitors to carry around cameras and or video cameras to capture those events. In addition, it is difficult to share the captured media and store them on easily accessible media.

Accordingly, there is a need to overcome the issues noted above.

### SUMMARY OF THE PREFERRED EMBODIMENTS

The present invention provides a personalized event multimedia capture system that includes a camera system and multimedia distribution network with a fully integrated kiosk solution. The kiosk includes software and hardware to provide user control in capturing personalized multimedia data such as video; an entertainment commerce system; a DVD authoring solution; and payment processing.

In one preferred embodiment, the system provides the user the ability to capture and retrieve a video image of the user performing a particular activity. The retrieved video image may then be authored onto a removable media such as a digital video disc (DVD) by the system and presented to the user. For example, a video recording system is integrated and installed to record customers at a ski resort and make the videos available for purchase at a DVD-burning kiosk. The system, using a plurality of cameras, captures videos of a particular activity location of interest so that a customer can ski through the area of activity and the system can capture a video of the customer performing the activity, such as a video of the customer skiing or snowboarding over a jump. Although the examples provided herein mainly refer to captured video, still images (i.e., photos or photographs) may also be captured by the system.

In one preferred embodiment, the system integrates cameras communicating with a wireless network to deliver the recorded video to the kiosk. The video is converted to a format compatible with the video playback and storage hardware/software in the kiosk. The system also provides a self-service point of purchase vending. Customers use an interactive touch screen to pick personalized digital media and services for purchase. They can see and choose their personalized image and video clips that were previously recorded in real-time.

The system also provides a software platform for securing, delivering, monitoring, and optimizing media commerce applications and content on kiosks, displays, PC terminals, and other networked devices. In one embodiment, the system is built for interactive self-service and the public access environment, and is designed to address the unique issues encountered in these customer deployments.

The system also provides a secure, reliable and scalable software platform for increased operational control of networks of self-service and digital merchandising devices. With an Internet-centric architecture, the platform provides software for self-service application deployment, security, peripheral integration, analytics and reporting, content optimization, and remote management. Other features of the system include:
The ability for remotely updating and managing the content in the network of the personalized event capturing system to keep it fresh and compelling to customers.
With robust content optimization capabilities, the system can easily download and activate new content to the network, from a single administrative access point.
The system provides for scheduled updates of the kiosk-based application and interface, allowing for rapid updating of the kiosk content in response to new or expanded product offerings, enhanced advertising opportunities, geographic preferences or dynamic market conditions. Thus, the system provides for an easy to use network to test marketing messages or launch new products.
The system further allows for the switching of content at the kiosk on a regularly scheduled basis, such as for events and promotions.
Further, the system monitors its self-service network for 24/7 mission critical reliability. If a failure is detected, an alert is sent for rapid response.
If the need arises, the system can remotely reboot a self-service device, eliminating the need for an on-site service call.

The video capture system generally operates as follows:
1. A user scans a unique identification (ID) tag (or badge) at an ID scanner station, and the ID number, timestamp and ID scanner station number are sent to the media station to be stored.
2. Camera stations capture videos and send the videos along with timestamp data to a media station, where the videos are stored by camera station number, camera station camera number and time.
3. The user returns to the media station and scans the ID tag. The Media station identifies the timestamp and associated ID scanner station data for the user's scanned ID tag. The media station then prepares the user's personalized clips for viewing. Taking into account predetermined timed inputs for each related ID scanner station; the clips are created based on start and finish times of the camera station capture for each of the user's scans at an ID scanner station.
4. Once user selects clips for purchase and payment is confirmed, the video file is encoded into MPEG-2 format and copied to DVD.

Other objects, features and advantages of the present invention will become apparent to those skilled in the art from the following detailed description. It is to be understood, however, that the detailed description and specific examples, while indicating preferred embodiments of the present invention, are given by way of illustration and not limitation. Many changes and modifications within the scope of the present invention may be made without departing from the spirit thereof, and the invention includes all such modifications.

### BRIEF DESCRIPTION OF THE DRAWINGS

The invention may be more readily understood by referring to the accompanying drawings in which:

FIG. 1 is a flow diagram of a method for operating a personalized event multimedia capture system;

FIG. 2 is a flow diagram of a method for capturing video in the personalized event multimedia capture system;

FIG. 3 is a block diagram of a video capture network of the personalized event multimedia capture system;

FIG. 4 is a flow diagram of a method of operation of the personalized event multimedia capture system as used in a golf course;

FIG. 5 is a flow diagram of the method of operation of the personalized event multimedia capture system as used at a tee or a driving range of the golf course;

FIG. 6 is a flow diagram of the method of operation of the personalized event multimedia capture system as used on a green of the golf course;

FIG. 7 is a flow diagram of a method of operation of the personalized event multimedia capture system as used on a golf cart in accordance with one embodiment of the present invention; and

FIGS. 8a-8f are screen shots of a user interface of the personalized event multimedia capture system.

Like numerals refer to like parts throughout the several views of the drawings.

### DETAILED DESCRIPTION OF THE PREFERRED EMBODIMENTS

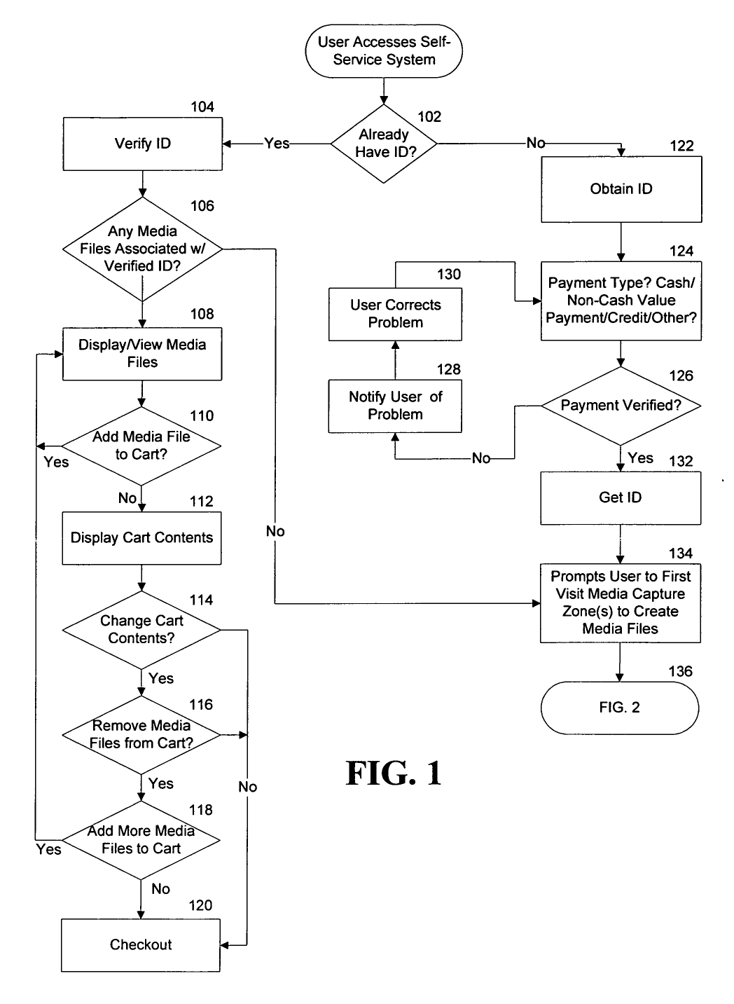

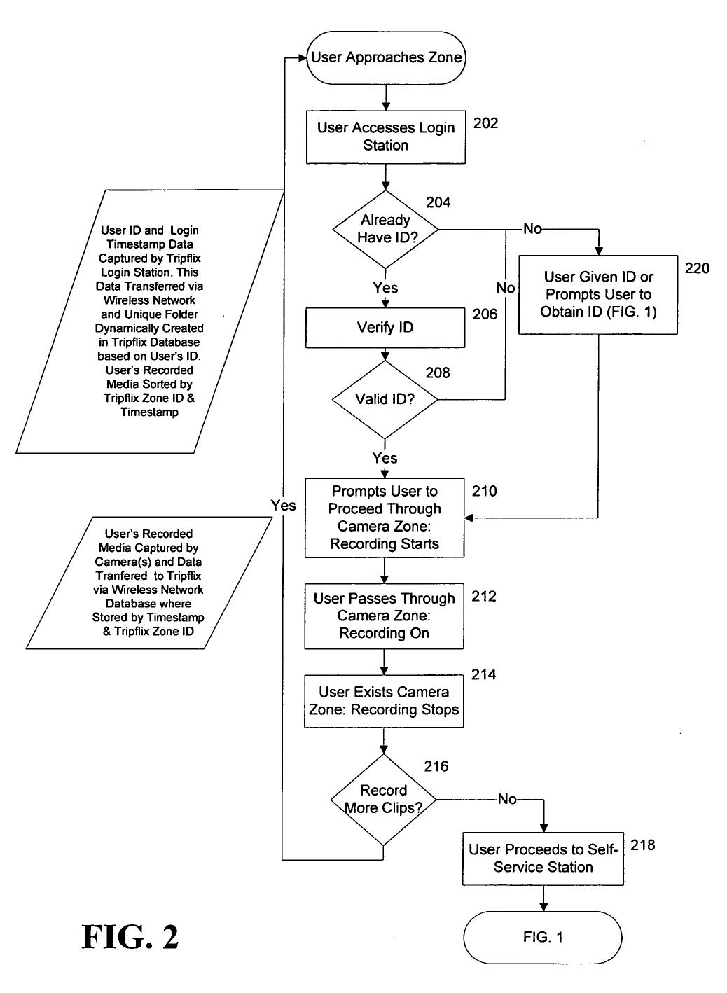

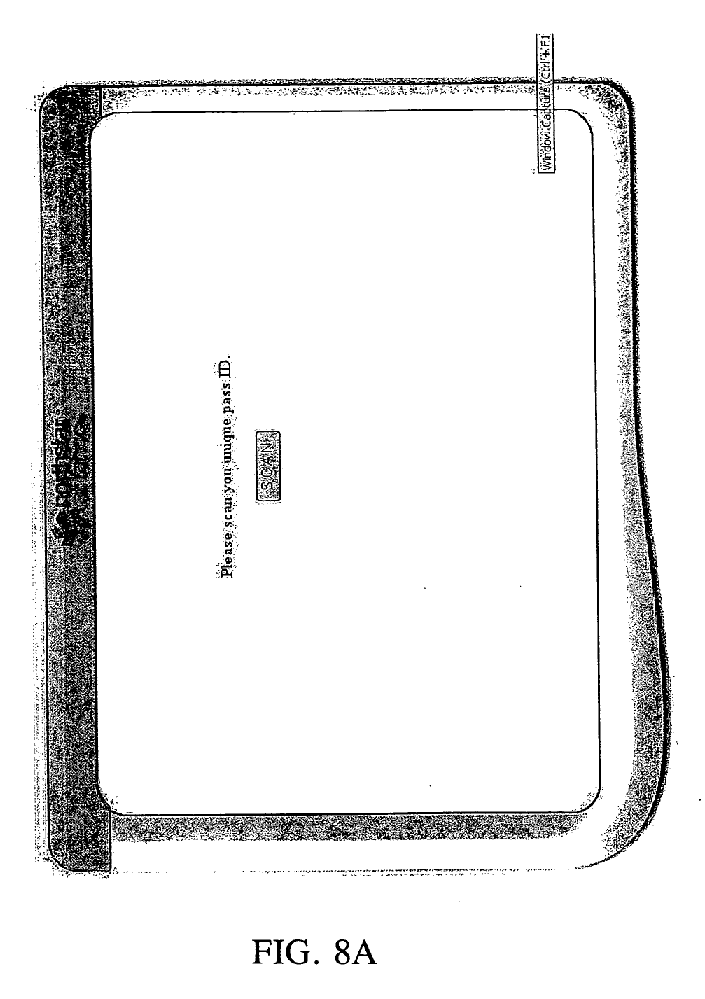

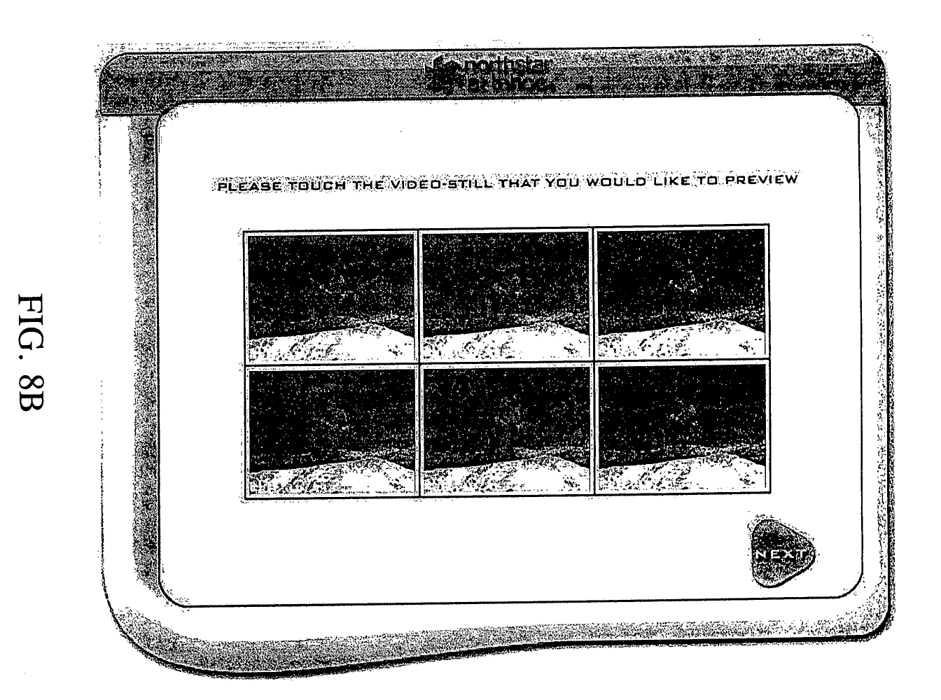

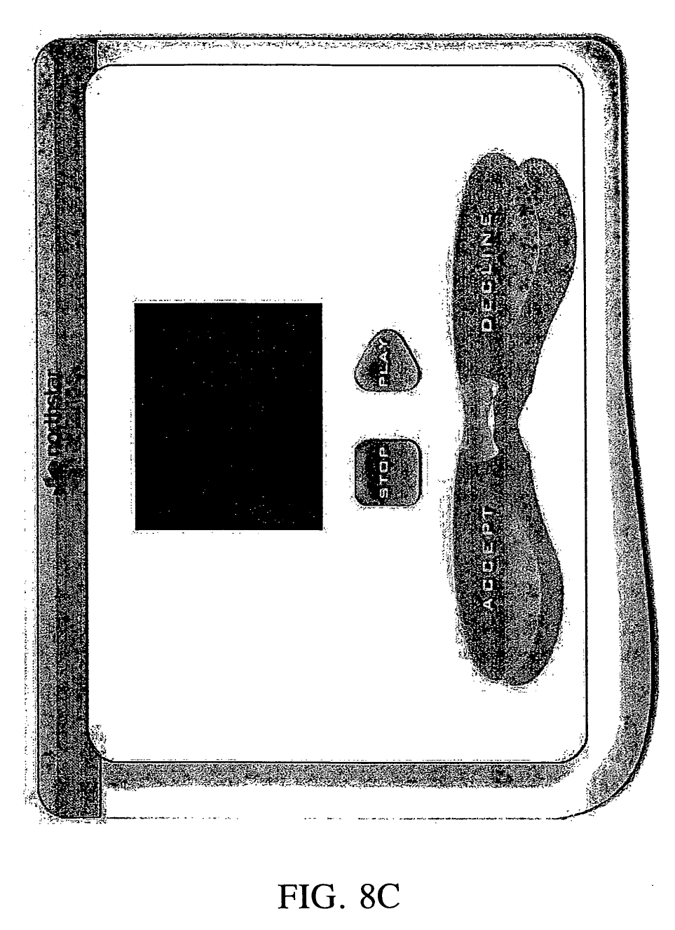

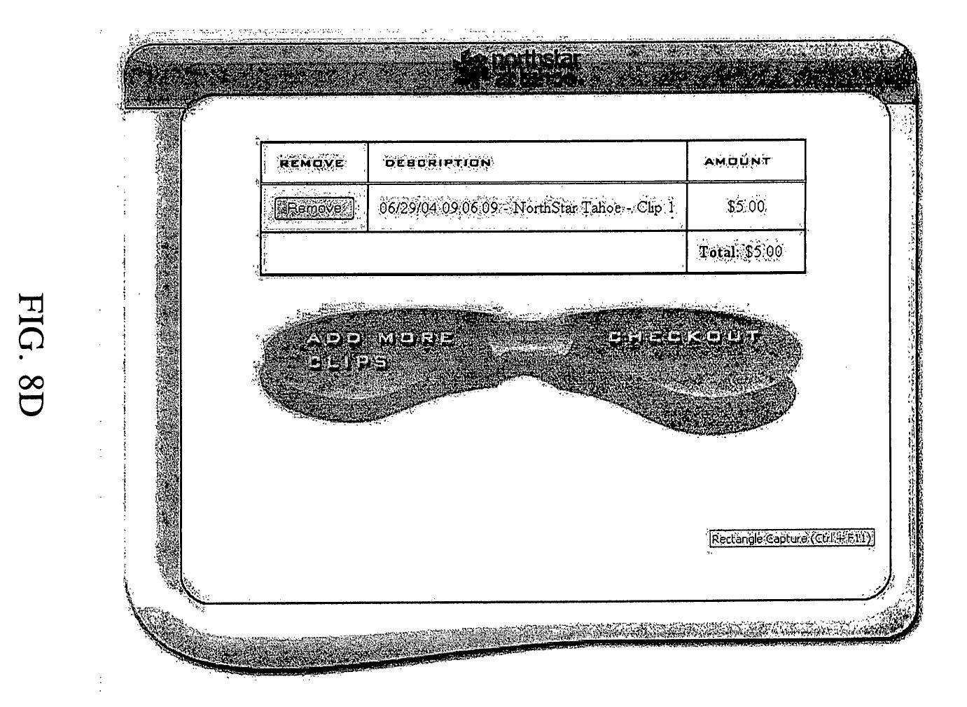

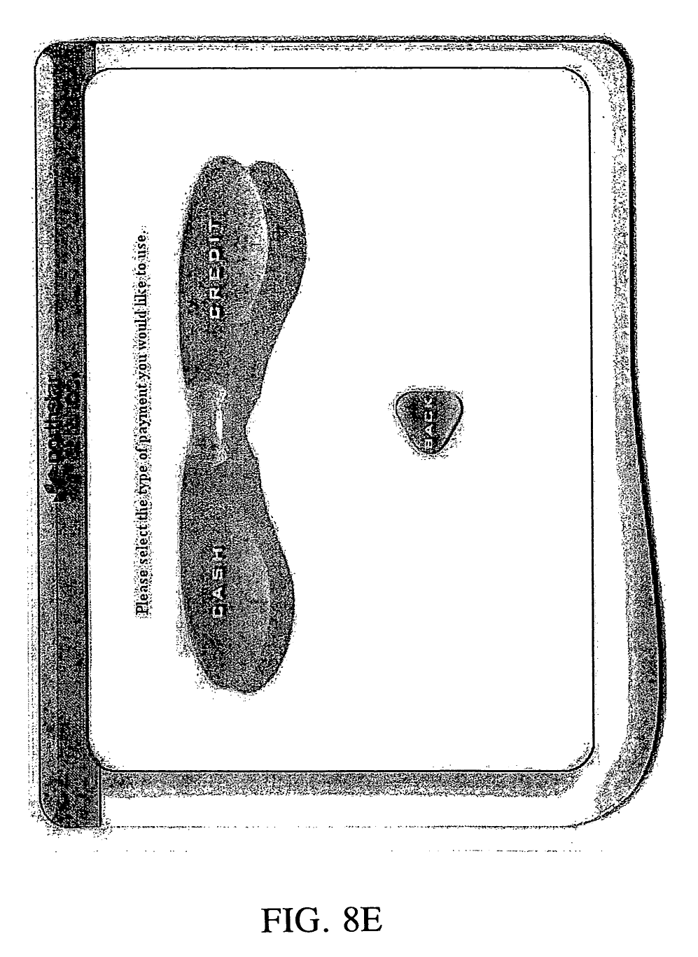

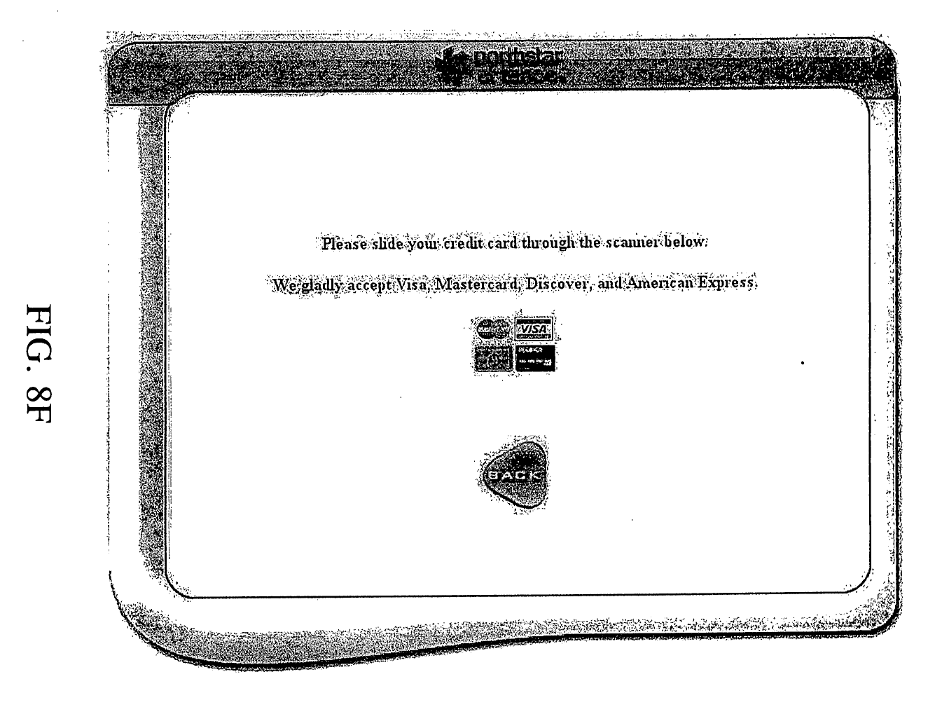

FIG. 1 is a flow chart illustrating the operation of the system in accordance with one embodiment of the present invention, beginning with a user approaching the self-service system such as at a kiosk. In step 102, the system determines if the user already has an ID. In one embodiment, the system asks the user to indicate whether the user has an ID and providing that ID through a user interface. In another embodiment, the user may swipe or scan an ID card that includes a bar code, magnetic strip or similar readable system. For example, the ski resort may provide season passes or lift passes that includes a bar code with a code. Or, the user may use a credit card, such as the one used to pay for use of the system. In yet another embodiment, the user may use a wireless ID such as a Bluetooth-enabled device or a radio frequency ID (RFID) tag. An exemplary interface is shown in FIG. 8a. If a user does not have an ID, then operation would continue with step 122.

In step 104, the system determines whether the ID that has been provided in step 102 is valid. In one embodiment, a valid ID is one in which the user has already paid the required payment or fee to use the system. In another embodiment, a valid ID is one that is associated with a valid payment form. Step 102 and 104 may be combined such that the determination of the existence and validity of the ID may be performed in one step. For example, in the embodiment where the user swipes a card with a bar code, the system may directly verify the ID i.e., whether the ID is in the system as a valid ID. Once the ID is verified, then operations proceed with step 106.

In step 106, the system searches for any media files that are associated with the provided and valid ID. If media files are found, then operation continues with step 108. If no media files are found, then operation proceeds with step 134, where the user is offered the option to create media files, as further described herein.

In step 108, the media files that are associated with the verified ID are presented for the user to view, as shown in FIG. 8b. In one embodiment, a table of one or more still images constructed from the media files is displayed to the user. If there are more media files than those capable of being displayed comfortably in one screen, then multiple pages may be used. For example, if displaying more than six images on the screen at the same time will result in images that are too small to see any details, but there are more than eight images to be displayed, then the images may be displayed over two pages. In another embodiment, instead of displaying still images, the system may display moving images such as a brief preview of the video. The user can then choose a particular file to preview in step 110.

In step 110, the user can preview and add the displayed files to an electronic shopping cart, as shown in FIG. 8c. The user can play the chosen media file by pressing a “Play” button or stop playback by pressing a “Stop” button. An “Accept button places the media file into the user's shopping cart, while a “Decline” button returns the user back to the previous screen to choose another media file. Once the user has chosen a file to add to the shopping cart, the system will display the cart contents in step 112, as shown in FIG. 8d, and determine if the user wishes to change the cart's contents in step 114. If the user is satisfied with the content of the cart, then operation proceeds with step 120, where the user can checkout by selecting the “Checkout” button and the media files would be burned to a suitable medium such as an optical disc (e.g., DVD) or delivered via a network. Otherwise, if the user wants to remove unwanted media files and clicks on a “Remove” button, a button being located next to each of the files, then operation will continue with step 116; or, if the user chooses to add more media files to the cart by clicking on an “Add More Clips” button, then operation will continue with step 118. An exemplary interface allowing the user to perform the described operations to the user's cart is illustrated in FIG. 8d.

Returning to step 102, if the system determines that the user does not have an ID, then operation continues with step 122, where a user may purchase an ID. In one embodiment, a user may be provided with an ID number, which may be password or associated with a private identification number (PIN). In another embodiment, an ID card may be presented to the user. In yet another embodiment, the system may use a pre-existing card or identification system such as that provided by the ski resort to generate (or, alternatively, create) and store an ID. Thus, the system may use a predetermined/pre-assigned ID, such as the one provided by the golf course. Other forms of suitable ID may be used.

In steps 124, 126, 128 and 130, the user is prompted for payment information, such as illustrated in FIG. 8e and 8f, which is then verified by the system and, if needed, corrected by the user. In other embodiments, non-payment registration may be used and an ID may be redeemable by a user filling out demographic and contact information form. Once the payment process is successful, then an ID is generated in step 132. As discussed above, if the system uses an existing ID, then there may not be a need to generate an ID for the user. However, an internal ID may be generated such that it is guaranteed that no ID is duplicated. In any case, the payment status may be associated with the ID at this point.

Once the ID is generated in step 132, or if the system cannot locate any media files in step 106, then in step 134 the system will prompt the user to visit one or more camera zones to create media files. The user would then progress to a camera zone in step 136, and logs in at a station using any of the aforementioned methods or technologies in step 138. Finally, the user would create the media files in step 140 by passing through the camera zone. One embodiment of the process of capturing the videos to create the media files is further described in FIG. 2.

FIG. 2 is a flow diagram illustrating the operation of the system where a user captures a recording using the system in one of the zones. In step 202, a user accesses the login or identification (ID) station. If the user already has an ID, as determined in step 204, operation continues with step 206, where the system verifies the ID of the user. Otherwise, in step 220, the user is given a unique ID or prompted to obtain an ID as described in step 122 of FIG. 1, and/or as further described below. The ID provided by the user may be in the form of a unique ID code, in RFID tag, a barcode tag, magnetic card or other form of ID.

If the ID is determined to be valid in step 208, the system will prompt the user to proceed through the camera zone and recording starts in step 210. In one embodiment, the system will detect when the user has entered the camera zone through the use of a light beam/reflector/photo detector system. In this example, the user will “break” the light beam upon passing between the reflector and the photo detector. In another embodiment, the user may pass by a switch and activate that switch by either pressing or stepping on the mechanism. In yet another embodiment, the system may detect the user entering the camera zone through the use of a motion detector. In yet still another further embodiment, the system may perform the detection through the use of a motion detection algorithm on the images captured by the camera.

In step 212, the user passes through the camera zone with the system recording the user's movements and/or actions in the field of view of the camera(s). It one embodiment, a single camera is used to capture a single location. In another embodiment, multiple cameras may be used to capture a single location through different camera angles, focal lengths, field of view, or camera effects. In yet another embodiment, the system will capture a video clip and/or one or more photographs of the user based on a timing trigger activated after the user's ID is determined to be valid in step 208.

Once the user has exited the camera zone in step 214, as detected by the system using the various motion detection systems identified above, recording will stop. If there are no more video clips or photographs to be captured as determined in step 216, then the user may proceed to the self-service station in step 218 to the self-service station so that the user may review the captured videos and photographs, and retrieve and store them onto a storage media such as a DVD, or published to a website, photo paper, or otherwise disseminated in analog or digital formats.

A general description of one embodiment of the software architecture used to implement the methods of the operation described herein is attached hereto as Appendix I, entitled “ActionCapture Technical Specification, V.1.0.”

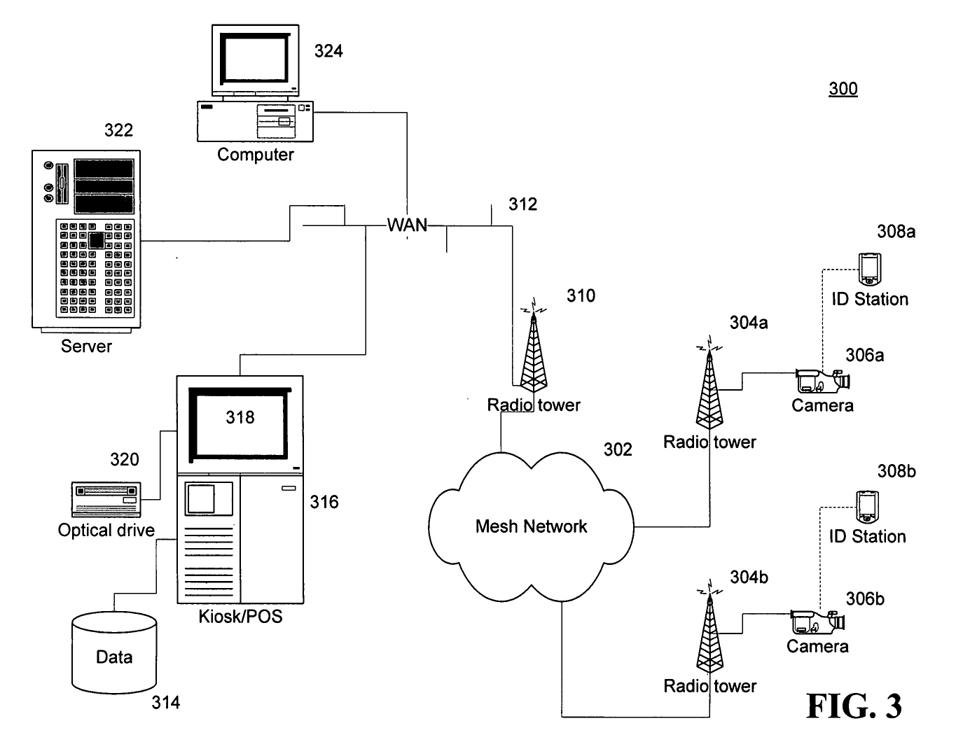

FIG. 3 is a block diagram of a personalize event capturing system 300 with a mesh network 302, a plurality of radio towers 304 connected to mesh network 302; a plurality of camera stations 306, each connected to a radio transceiver; and a plurality of terminals 308 controlling a respective camera location. Connected to mesh network 302 is a radio transceiver 310 that is coupled to a wide area network (WAN) 312. Radio transceiver 310 bridges the connection between mesh network 203 and WAN 312 so that a kiosk 316 can retrieve the data received at a particular camera. FIG. 3 also shows a server 322 that is coupled to WAN 312, which, in other embodiments, serves as a central repository for the information that is captured by cameras 308 and data stored on kiosk, 316.

In one embodiment, each ID Station 308 is coupled to control a single camera 306, which is coupled to mesh network 302 by a radio transceiver 304. In other embodiments, multiple cameras 306 may be controlled by a camera station (not shown), which is coupled to mesh network 302. Thus, multiple cameras, ID stations, and radio transceivers may be deployed to provide the desired coverage for the locations of interest.

The value of mesh network 302 increases as its number of connection points (e.g., radio towers 304) increases. Thus, utilizing mesh network 302, system 300 can scale to accommodate the number of camera stations/cameras, ID stations, and point of sales (POS) stations without compromising bandwidth throughput, minimizing network latency, and creating a “plug-and-play” installation process for our premise equipment. Further, there is no central “orchestrating device” in mesh network 302. Instead, each wireless node is outfitted with radio communications gear and acts as a relay point for other nodes. This allows mesh network 302 to be more reliable than other kinds of networks, because if a single wireless node (i.e., radio tower 304) goes down, other nodes are available. In other embodiments, wired or non-mesh wireless network technologies can be used to provide network connectivity.

Camera 306 is a wireless network camera that generates video and other multimedia files compliant with the JPEG/Motion JPEG & MPEG2 formats. In one embodiment, camera 306 generates videos at 22 frames per second at a resolution of 320×240. In another embodiment, camera 306 is a wired network camera. In yet another embodiment, camera 306 is an analog camera that includes an analog bridge to couple with mesh network 302. Cameras near each other will be hardwired together to reduce wireless nodes.

In one embodiment, system 300 utilizes the Integrated Performance Primitives (IPP) system offered by Intel® for DVD file format real-time encoding and image processing. The IPP system is a software library that provides a broad range of functionality, including general signal, image, speech, graphics, text strings and audio processing, vector manipulation and matrix math, as well as more sophisticated primitives for construction of audio, video and speech codec such as MP3 (MPEG-1 Audio, Layer 3), MPEG-2, MPEG-4, H.263, JPEG, JPEG2000, GSM-AMR* and G.723, plus computer vision. The IPP system delivers a rich set of encoding and image processing options to choose from while designing and optimizing an application supporting a variety of data types and layouts for each function and minimizing the number of data structures used.

In one embodiment, the user interface for Kiosk 316 is provided by a touch screen monitor 318. An exemplary set of screenshots is shown in FIGS. 8a-8f. In other embodiments, the user interface may be implemented using a monitor and keyboard; a personal digital assistant (PDA) or other user networked device; a browser-enabled cellular phone; an Internet website; or by telephone.

The payment system can accept payment using a card scanner (credit/debit card); a bill acceptor (cash/coupons); electronic payments (PayPal™, VeriSign™, etc.); and/or a storage device (RFID, loyalty card, etc.) built into kiosk 316. In another embodiment, the payment system may accept payment using reverse SMS billing (cellular); or a telephone billing system (“1-900” numbers, tolled numbers, etc.).

Kiosk 316 includes an optical drive 310 such as a DVD/CD-ROM Burner for distributing the captured video. In another embodiment, the distribution may be done through a Video Cassette Recorder (VCR); Wireless Access Points (e.g., 802.11x or Bluetooth); or any one of the Internet data transfer modalities (e.g., E-mail, FTP, HTTP).

System 300 may be used in a variety of applications, including the capture of video in a golf course (e.g., where the cameras are placed at one or more tees and holes as well as sand traps or water features); a skate park (e.g., near ramps or jumps as well as rails); a water slide park (e.g., at the bottom and top of a slide as well); and other types of venues where it is desirable to capture personalized video.

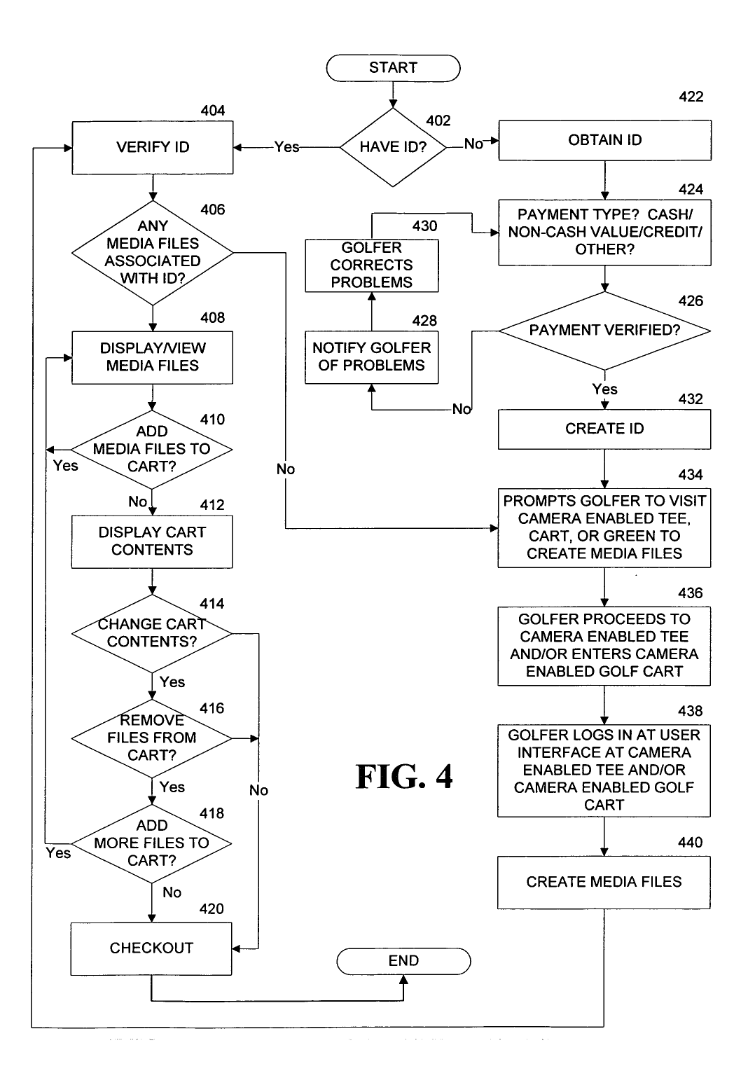

FIG. 4 is a flow chart illustrating the operation of the system for golf courses in accordance with another embodiment of the present invention, beginning with a golfer approaching the self-service system. In step 402, the system determines if the golfer already has an ID. In one embodiment, the system asks the golfer to indicate whether the golfer has an ID and providing that ID through a user interface. In another embodiment, the golfer may swipe or scan an ID card that includes a bar code, magnetic strip or similar readable system. For example, the golf course may provide membership card or scorecard that includes a bar code with a code. In yet another embodiment, the golfer may use a wireless ID such as a Bluetooth-enabled device or a radio frequency ID (RFID) tag. If a golfer does not have an ID, then operation would continue with step 422.

In step 404, the system determines whether the ID that has been provided in step 402 is valid. In one embodiment, a valid ID is one in which the golfer has already paid the required payment or fee to use the system. In another embodiment, a valid ID is one that is associated with a valid payment form. Step 402 and 404 may be combined such that the determination of the existence and validity of the ID may be performed in one step. For example, in the embodiment where the golfer swipes a card with a bar code, the system may directly verify the ID—i.e., whether the ID is in the system as a valid ID. Once the ID is verified, then operations proceeds with step 406.

In step 406, the system searches for any media files that are associated with the provided and valid ID. If media files are found, then operation continues with step 408. If no media files are found, then operation proceeds with step 434, where the golfer is directed to create media files, as further described herein.

In step 408, the media files that are associated with the verified ID are presented for the golfer to view. The golfer can then choose to add the displayed files to an electronic shopping cart in step 410. Once the golfer has chosen a file to add to the shopping cart, the system will display the cart contents in step 412, and allow the golfer to change the cart's contents in step 414. If the golfer is satisfied with the content of the cart, then the golfer can checkout in step 420 where the media files are burned onto a DVD or transmitted using other methods of delivery of media. Otherwise, the golfer may remove unwanted media files in step 416, or choose to add more media files to the cart in step 418.

Returning to step 402, if the system determines that the golfer does not have an ID, then operation continues with step 422, where a golfer may purchase an ID. In one embodiment, a golfer may be provided with an ID number, which may be password or associated with a private identification number (PIN). In another embodiment, an ID card may be presented to the golfer. In yet another embodiment, the system may use a pre-existing card or identification system such as that provided by the golf course to generate (or, alternatively, create) and store an ID.

In steps 424, 426, 428 and 430, the golfer is prompted for payment information, which is then verified by the system and, if needed, corrected by the golfer. Once the payment process is successful, then an ID is generated in step 432. As discussed above, if the system uses an existing ID, then there may not be a need to generate an ID for the golfer. However, an internal ID may be generated such that it is guaranteed that no ID is duplicated.

Once the ID is generated in step 432, or if a golfer attempts to locate media files that have not been created in step 434, then the system will prompt the golfer to visit one or more camera enabled tees or enter camera enabled golf cart to create media files. The golfer would then progress to a camera enabled tee or enter camera enabled golf cart in step 436, and logs in at a station or golf cart user interface using any of the aforementioned methods or technologies in step 438. Finally, the golfer would create the media files in step 440 by teeing off at the camera enabled tee or selecting recording start and stop for the golf cart camera or logging putting start timestamps and green number for related green camera clips.

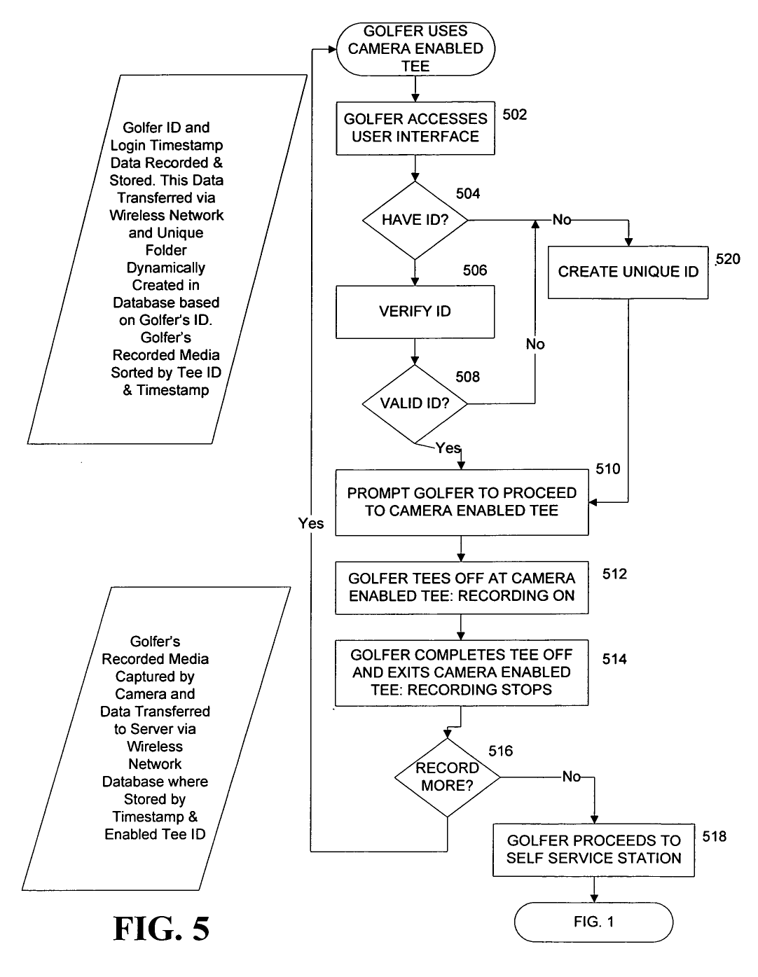

FIG. 5 is a flow diagram illustrating the operation of the system where the golfer captures a recording using the system at one of the camera enabled tees. In step 502, a golfer accesses the login or identification (ID) station. If the golfer already has an ID, as determined in step 504, operation continues with step 506, where the system verifies the ID of the golfer. Otherwise, in step 520, the golfer is given a unique ID, as described. The ID provided by the golfer may be in the form of a unique ID code, in RFID tag, a barcode tag, magnetic card or other form of ID.

If the ID is determined to be valid in step 508, the system will prompt the golfer to proceed through the camera enabled tee and recording starts in step 510. In one embodiment, the system will detect when the golfer has entered the camera zone through the use of a light beam/reflector/photodetector system. In this example, the golfer will “break” the light beam upon passing between the reflector and the photodetector. In another embodiment, the golfer may pass by a switch and activate that switch by either pressing or stepping on the mechanism. In yet another embodiment, the system may detect the golfer entering the camera zone through the use of a motion detector. In still yet another embodiment, the system may perform the detection through the use of motion detection algorithm on the images captured by the camera.

In step 512, the golfer passes through the camera enabled tee with the system recording the golfer's movements and/or actions in the field of view of the camera(s). It one embodiment, a single camera is used to capture a single location. In another embodiment, multiple cameras may be used to capture a single location through different camera angles, focal lengths, field of view, or camera effects.

Once the golfer has teed off and exited the camera enabled tee in step 514, as detected by the system using the various motion detection systems identified above, recording will stop. If there are no more video clips to be captured as determined in step 516, then the golfer may proceed to the self-service station in step 518 to complete his or her review of the captured videos, and retrieve and store them onto a storage media such as a DVD. In yet another embodiment, the system will capture a video clip and/or one or more photographs of the user based on a timing trigger activated once the user's ID is determined to be valid in step 508. For example, a photo camera at a tee photo camera-enabled zone can take 3-5 photos of each ID activated user session.

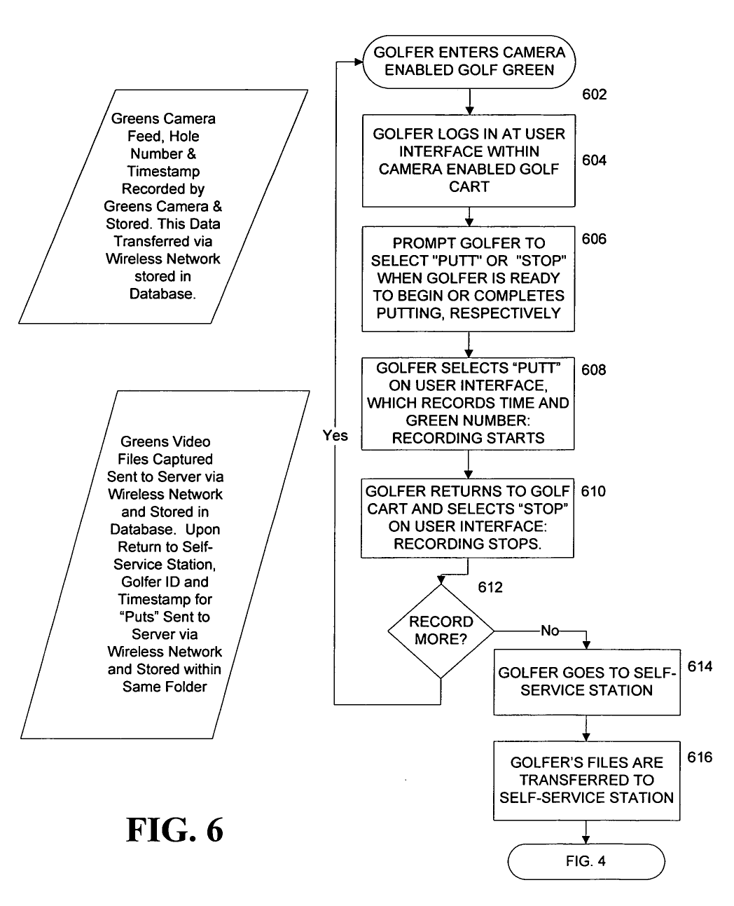

FIG. 6 is a flow diagram illustrating the operation of the system where a golfer captures a recording using the system in one of the camera enabled golf greens. In step 602, a golfer, prior to beginning to put, accesses the login interface within a camera enabled golf cart. If the golfer already has an ID, as determined in step 604, operation continues with step 606, where the system verifies the ID of the golfer.

If the ID is determined to be valid in step 604, the system will both visually and textually displays instructions that the golfer is to select “Put” or “Stop” when the golfer is ready to begin putting or upon completion of putting respectively.

In step 606, once golfer selects “Put,” the timestamp and hole number is recorded locally under a session folder created for the golfers' unique ID.

Once the golfer has completed putting and returned to the camera enabled golf cart in step 608, the golfer will select “Stop” and stop timestamp will be recorded locally. If there are no more holes(s) and/or strokes to be captured, as determined in step 610, then the golfer may drive to the self-service station in step 614 to transfer recorded video and photo files in step 616 to the self-service station for subsequent review of the captured videos and photos and retrieve and publish those to photo paper, DVD, a website, and/or other formats.

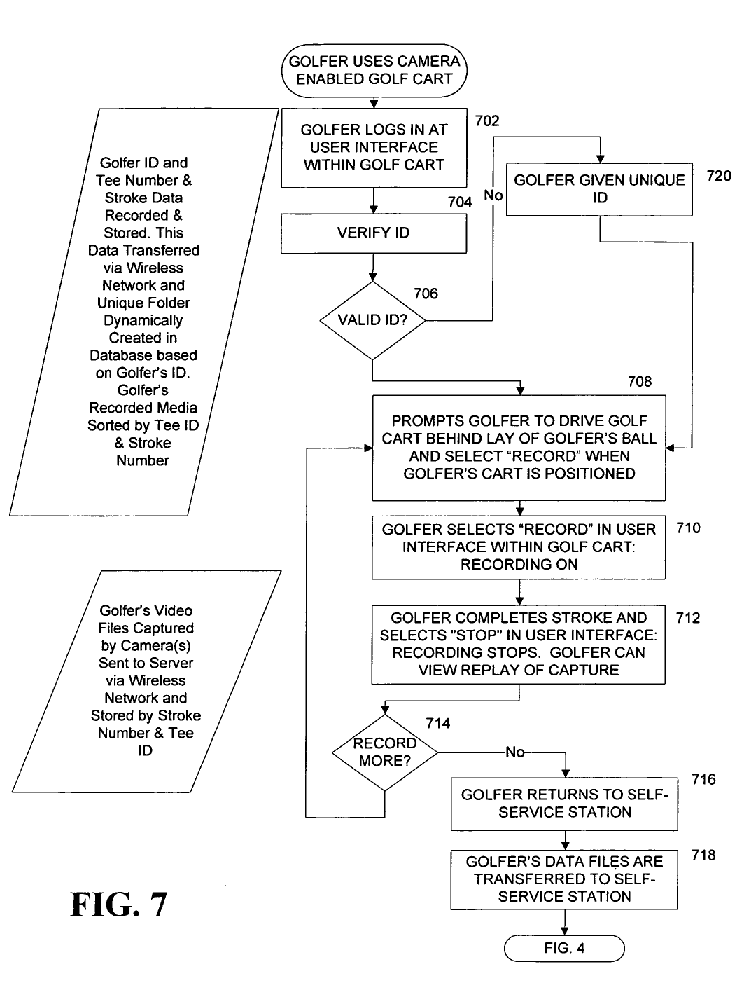

FIG. 7 is a flow diagram illustrating the operation of the system where a golfer captures a recording using the system in one of the camera enabled golf cart. In step 702, a golfer accesses the login or identification (ID) interface within the camera enabled golf cart. If the golfer already has an ID, as determined in step 704, operation continues with step 706, where the system verifies the ID of the golfer. Otherwise, in step 720, the golfer is given a unique ID, as further described below. The ID provided for another golfer may be in the form of a unique ID code, a RFID tag, a barcode tag, magnetic card or other form of ID.

If the ID is determined to be valid in step 708, the system will prompt the golfer to drive directly behind the lay of the golfer's ball and both visually and textually displays instructions that, once the golfer's cart is positioned so that the camera's field of view as seen on golf cart's user interface has the golfer's ball in line with hole, that golfer can select “Record.” Once the golfer selects “Record” recording starts through the camera enabled golf cart in step 710.

Once the golfer has completed the golfer's stroke and returned to the camera enabled golf cart in step 712, as instructed by the user interface, and “Stop” is selected by the golfer, the recording will stop. User may view replay of most recent stroke. If there are no more tee(s) and/or video clips and/or photographs to be captured, as determined in step 714, then the golfer may drive to the self-service station in step 716 to transfer recorded video and photograph files in step 718 to the self-service station so that the golfer may review the captured videos and photographs, and retrieve and store them onto a storage media such as a DVD, or published to a website, photo paper, or otherwise disseminated in analog or digital formats.

The embodiments described above and as further described in the documents contained in the attached appendix are exemplary embodiments of a personalized event media capture system of the present invention. Those skilled in the art may now make numerous uses of, and departures from, the above-described embodiments without departing from the inventive concepts disclosed herein.

What is claimed is:

1. A method for capturing personalized multimedia for a user comprising:
scanning a unique identification (ID) number for the user at an ID scanner station;
capturing multimedia information for the unique ID using at least one multimedia capture device associated with the ID scanner station; and
sending the multimedia information, along with the unique ID and timestamp data to a media station for storage.

2. The method of claim 1, wherein the multimedia capture device is a video camera.

3. The method of claim 1, wherein storing the unique ID number comprises storing an ID scan timestamp and an ID scanner station number.

4. The method of claim 1, further comprising storing the multimedia information indexed by a camera station number, a camera station camera number and a time.

5. The method of claim 1, further comprising:
receiving a scan of the unique ID;
preparing the multimedia information for review by the user;
receiving a selection of the multimedia information for purchase; and
encoding the multimedia information for storage on a first distribution medium.

6. The method of claim 5, wherein preparing the multimedia information for review by the user comprises identifying timestamp data and the ID scanner station for the multimedia information.

7. The method of claim 5, wherein preparing the multimedia information for review by the user comprises:
taking into account predetermined a timed input of the unique ID scan at the ID scanner station; and
creating at least one clip from the multimedia information based on at least one starting time and one finishing time of the captured multimedia information.

8. A computer readable medium having instructions stored thereon, the stored instructions, when executed by a processor, cause the processor to perform a method for capturing personalized multimedia for a user comprising:
scanning a unique identification (ID) number for the user at an ID scanner station;
capturing multimedia information for the unique ID using at least one multimedia capture device associated with the ID scanner station; and
sending the multimedia information, along with the unique ID and timestamp data to a media station for storage.

9. The computer readable medium of claim 8, wherein the multimedia capture device is a video camera.

10. The computer readable medium of claim 8, wherein storing the unique ID number comprises storing an ID scan timestamp and an ID scanner station number.

11. The computer readable medium of claim 8, the method further comprising storing the multimedia information indexed by a camera station number, a camera station camera number and a time.

12. The computer readable medium of claim 8, the method further comprising:
receiving a scan of the unique ID;
preparing the multimedia information for review by the user;
receiving a selection of the multimedia information for purchase; and
encoding the multimedia information for storage on a first distribution medium.

13. The computer readable medium of claim 12, wherein preparing the multimedia information for review by the user comprises identifying timestamp data and the ID scanner station for the multimedia information.

14. The computer readable medium of claim 12, wherein preparing the multimedia information for review by the user comprises:
taking into account a predetermined time of the unique ID scan at the ID scanner station; and
creating at least one clip from the multimedia information based on at least one starting time and one finishing time of the captured multimedia information.

15. An apparatus for capturing personalized multimedia for a user comprising:
means for scanning a unique identification (ID) number for the user at an ID scanner station;
means for capturing multimedia information for the unique ID using at least one multimedia capture device associated with the ID scanner station; and
means for sending the multimedia information, along with the unique ID and timestamp data to a media station for storage.

16. The apparatus of claim 15, wherein the multimedia capture device is a video camera.

17. The apparatus of claim 15, wherein the means for storing the unique ID number comprises means for storing an ID scan timestamp and an ID scanner station number.

18. The apparatus of claim 15, further comprising means for storing the multimedia information indexed by a camera station number, a camera station camera number and a time.

19. The apparatus of claim 15, further comprising:
means for receiving a scan of the unique ID;
means for preparing the multimedia information for review by the user;
means for receiving a selection of the multimedia information for purchase; and
means for encoding the multimedia information to be stored on a first distribution medium.

20. The apparatus of claim 19, wherein the means for preparing the multimedia information for review by the user comprises means for identifying timestamp data and the ID scanner station related to the captured multimedia information.

21. The apparatus of claim 19, wherein the means for preparing the multimedia information for review by the user comprises:
means for taking into account a predetermined time of the unique ID scan at the ID scanner station; and
means for creating at least one clip from the multimedia information based on at least one starting time and one finishing time of the captured multimedia information.
